(19) United States
(12) Patent Application Publication
(10) Pub. No.: US 2007/0133019 A1
(43) Pub. Date: Jun. 14, 2007

(54) Transparency printing

(75) Inventors: Ryan C. Hill, Mountain View, CA (US); Peter T. Lai, Mountain View, CA (US); Jeffrey R. Rambharack, Los Gatos, CA (US); Andreas M. Scheidegger, San Jose, CA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/301,499

(22) Filed: Dec. 13, 2005

(51) Int. Cl. H04N 1/60

(52) U.S. Cl. 358/1.9

(57) ABSTRACT

Transparent content and opaque content that is contained within a document is treated differently for printing. The transparent content within a document is rasterized and stored in a system-managed bitmap before printing. While rasterization is effective for maintaining visual fidelity of transparent content it can lead to large spool files and poor performance if excessively performed. In order to help optimize the performance of output devices, the transparent content within the document is rasterized and the opaque vector content within the document is drawn into a metafile before printing. The metafile is replayed onto the printer and into the bitmap such that the opaque content can be blended with the rasterized transparent layers that are contained within the bitmap. The bitmap is then drawn on the printer.

### BACKGROUND

Printer technology has not advanced as rapidly as on-screen graphics technology. As a result, there is a disparity between what can be rendered on a screen and what can be printed. To make things worse, the way a document is printed varies from printer to printer. For example, some printers may not print transparencies very well. This variation among output devices makes device independence difficult, if not impossible. Additionally, the life cycle for printers is much longer than that of personal computers (PCs). The life cycle for printers may be from 7-10 years as compared to 2-3 years for a PC. As a result, software manufacturers are required to provide support for outdated printers that are still in use.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Transparent content and opaque content that is contained within a document is treated differently for printing. The transparent content within a document is rasterized and stored in a bitmap before printing. While rasterization is effective for maintaining visual fidelity of transparent content it can lead to large spool files and poor performance if excessively performed. In order to help optimize the performance of output devices, the transparent content within the document is rasterized and the opaque vector content within the document is drawn into a metafile before printing. The metafile is replayed onto the printer and into the bitmap such that the opaque content can be blended with the rasterized transparent layers that are contained within the bitmap. The bitmap is then drawn on the printer.

### BRIEF DESCRIPTION OF THE DRAWINGS

FIG. 1 illustrates an exemplary computing architecture for a computer;

FIG. 2 shows an overview of the printing path data flow for printing a document containing transparent and opaque content;

FIG. 3 illustrates an exemplary document that contains transparent and opaque objects;

FIG. 4 illustrates a process for printing layered opaque and transparent objects;

FIG. 5 shows blending overlapping transparent and opaque regions; and

FIG. 6 illustrates selecting a resolution for the output of the document, in accordance with aspects of the present invention.

### DETAILED DESCRIPTION

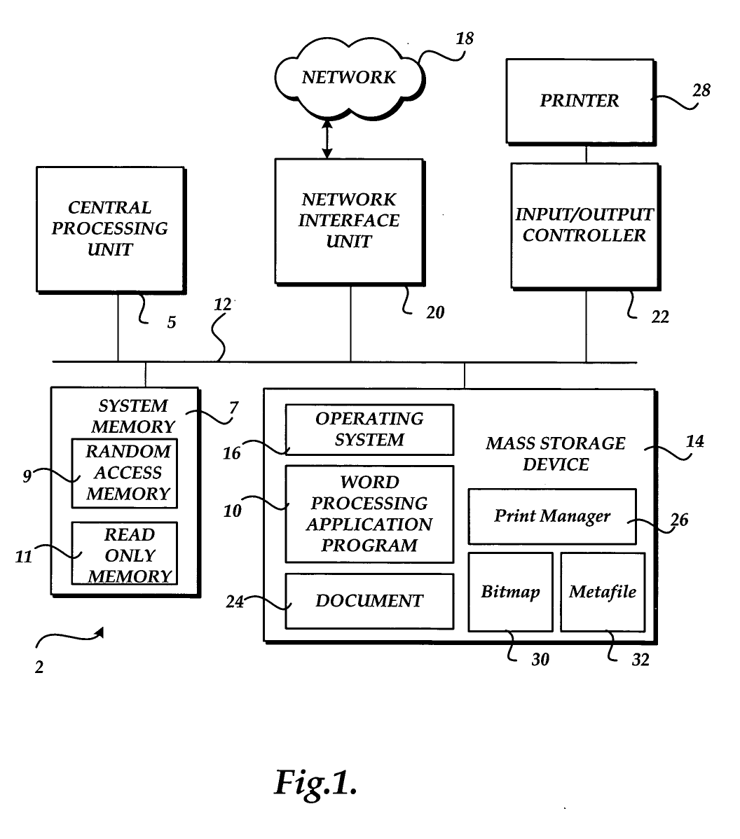

Referring now to the drawings, in which like numerals represent like elements, various aspects of the present invention will be described. In particular, FIG. 1 and the corresponding discussion are intended to provide a brief, general description of a suitable computing environment in which embodiments of the invention may be implemented.

Generally, program modules include routines, programs, components, data structures, and other types of structures that perform particular tasks or implement particular abstract data types. Other computer system configurations may also be used, including hand-held devices, multiprocessor systems, microprocessor-based or programmable consumer electronics, minicomputers, mainframe computers, and the like. Distributed computing environments may also be used where tasks are performed by remote processing devices that are linked through a communications network. In a distributed computing environment, program modules may be located in both local and remote memory storage devices.

Throughout the specification and claims, the following terms take the meanings explicitly associated herein, unless the context clearly dictates otherwise.

The term “Alpha Channel” refers to the fact that in ARGB (alpha, red, green, blue) bitmaps, each pixel has a channel that represents its transparency in addition to its red, green and blue channels.

The term “Bitmap” is a raster image (see ‘raster’ below).

The term “Device Context (DC)” refers to a structure that defines a set of graphics objects, their associated attributes, and the graphic modes that affect their output.

The term “Enhanced Metafile (EMF)” is a MICROSOFT WINDOWS native vector graphics format used frequently in applications.

The term “hDC” refers to a handle to a device context.

The term “Opaque” refers to a property of a visual object that makes objects behind not visible.

The term “Pass-through” refers to a method to send data directly to the printer, bypassing the printer driver.

The term “Page Description Language (PDL)” is a language that resides on a printer to translate documents into printer instructions.

The term “Planar Map” is a technique that divides the print area into regions and drawing the edges and intersections of objects in the region.

The term “Raster” refers to pixel-based graphics. If expanded past the original pixel dimensions, interpolation is done to determine the color or the space between pixels.

The term “Screen Door” is a stippling technique used to simulate transparency, similar to looking through a screen door.

The term “Translucency (or Semi-Transparency)” refers to partial transparency.

The term “Transparency” refers to a property of a visual object that makes objects behind it visible. As used herein, the terms translucency and transparency may be used interchangeably.

The term “Vector” refers to graphics that are defined by their geometry. These graphics can be scaled to any size without loss of quality.

Referring now to FIG. 1, an illustrative computer architecture for a computer 2 utilized in the various embodiments will be described. The computer architecture shown in FIG. 1 illustrates a conventional desktop or laptop computer, including a central processing unit 5 (“CPU”), a system memory 7, including a random access memory 9 (“RAM”) and a read-only memory (“ROM”) 11, and a system bus 12 that couples the memory to the CPU 5. A basic input/output system containing the basic routines that help to transfer information between elements within the computer, such as during startup, is stored in the ROM 11. The computer 2 further includes a mass storage device 14 for storing an operating system 16, application programs, and other program modules, which will be described in greater detail below.

The mass storage device 14 is connected to the CPU 5 through a mass storage controller (not shown) connected to the bus 12. The mass storage device 14 and its associated computer-readable media provide non-volatile storage for the computer 2. Although the description of computer-readable media contained herein refers to a mass storage device, such as a hard disk or CD-ROM drive, the computer-readable media can be any available media that can be accessed by the computer 2.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 2.

According to various embodiments of the invention, the computer 2 may operate in a networked environment using logical connections to remote computers through a network 18, such as the Internet. The computer 2 may connect to the network 18 through a network interface unit 20 connected to the bus 12. The network interface unit 20 may also be utilized to connect to other types of networks and remote computer systems. The computer 2 may also include an input/output controller 22 for receiving and processing input from a number of other devices, including a keyboard, mouse, or electronic stylus (not shown in FIG. 1). Similarly, an input/output controller 22 may provide output to a display screen, a printer 28, or other type of output device.

As mentioned briefly above, a number of program modules and data files may be stored in the mass storage device 14 and RAM 9 of the computer 2, including an operating system 16 suitable for controlling the operation of a networked personal computer, such as the WINDOWS XP operating system from MICROSOFT CORPORATION of Redmond, Wash. The mass storage device 14 and RAM 9 may also store one or more program modules. In particular, the mass storage device 14 and the RAM 9 may store a word processing application program 10. The application program 10 is operative to provide functionality for creating, editing and printing electronic documents, such as the document 24. According to one embodiment, the application program 10 comprises the MICROSOFT WORD word processing application program from MICROSOFT CORPORATION. According to another embodiment, the application program 10 comprises the MICROSOFT POWERPOINT presentation program from MICROSOFT CORPORATION. Other programs may also be utilized. For instance, desktop publishing programs, presentation programs, web browsers, and any other type of program that print documents containing transparent objects may be utilized.

In conjunction with the editing of a document, the application program 10 provides functionality for printing transparent, semi-transparent, and opaque objects that comprise document 24. The application program 10 may utilize a print manager 26 to assist in the printing of the document 24. As will be described in greater detail below, the print manager 26 identifies the transparent content and the opaque content that is within a document; rasterizes the transparent content; stores the rasterization in a system-managed bitmap 30; and draws the opaque vector content into a metafile 32. The metafile 32 is then replayed onto the printer 28 and into the bitmap 30 such that the opaque content can be blended with the rasterized transparent layers that are contained within the bitmap. The bitmap is also drawn on the printer 28.

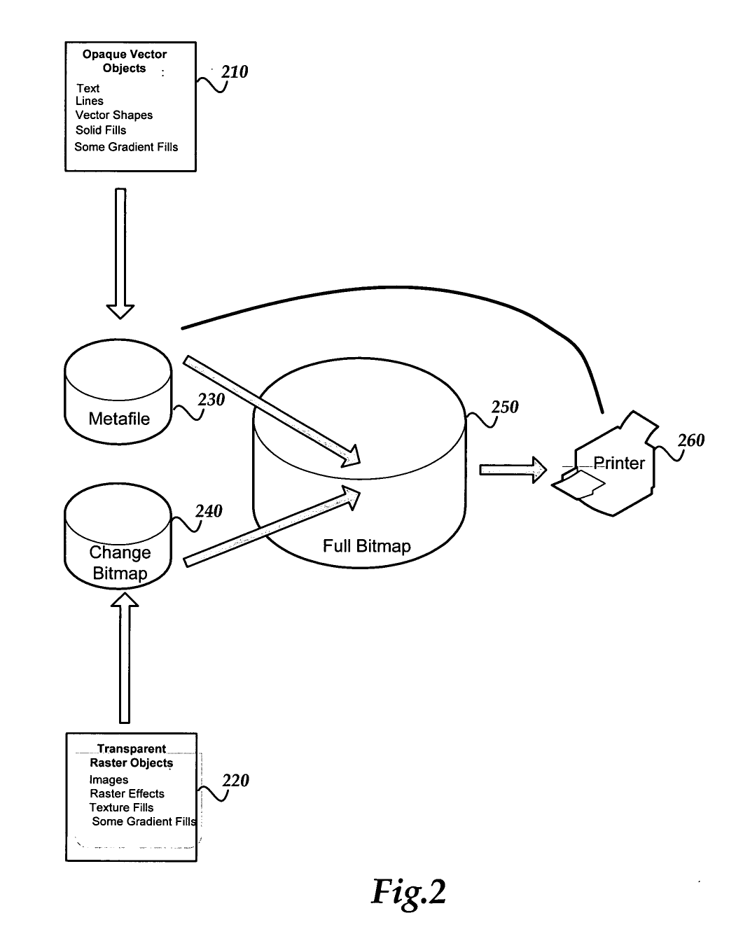

FIG. 2 shows an overview of the printing path data flow for printing a document containing transparent and opaque content. Transparent objects and opaque objects that are contained within a document are handled differently depending on their nature and the output device. The following is a general discussion of the types of printable objects that are contained within a document. The discussion is provided as an example and is not intended to be limiting. For example, there may be many other types of printable objects and they may be handled in different ways.

Opaque objects, such as vector objects 210, which are contained within a document, are typically sent to a metafile 230 before printing. Vector objects include items such as text, lines, vector shapes, solid fills, some gradient fills and the like. Opaque objects may be rasterized depending on whether or not they are obscured by transparent content. According to one embodiment, when an opaque object is obscured by transparent content, at least the region that is obscured is rasterized and sent to change bitmap 240.

Transparent objects are rasterized into a change bitmap 240. The transparent objects 220 include items such as images, raster effects, texture fills, some gradient fills and the like.

Generally, solid text is treated as an opaque object 210 and is written to the metafile 230 then replayed to the full bitmap 250 if the text is not obscured by a transparent object. If the text is obscured, the transparent area is rasterized and alpha blended and placed within change bitmap 240.

Although images are generally raster content they are printed through the metafile 230 unless they need to be blended in the bitmap. Generally, solid vector shapes 210 are written to the metafile 230 if they are not obscured by transparent objects. Gradient fills can be printed through the metafile or the bitmap. According to one embodiment, gradient fills are printed to the bitmap since it has been found that the quality is better when printed through the bitmap than through the metafile.

Shapes that include semitransparent fills and complicated line styles are rasterized. The fill is rasterized since it is semitransparent. According to one embodiment, if an object is obscured by one or more semitransparent objects then the entire transparent region is rasterized even if there are vector shapes below it. Similarly, raster effects (eg. soft shadow, soft edges, blur) are printed as raster objects.

Any of the objects within a document may be transparent or semi-transparent. If there are any semi-transparent regions in an object then those regions are rasterized and printed to the change bitmap 240. Texture fills are tiled raster images so they are printed to the change bitmap 240. Pattern fills and pattern lines are rendered as texture bitmaps and scaled to print at the right size. Tables are broken up so that effects applied to the table are rasterized but table text and lines are drawn through the metafile.

The metafile 230 and the change bitmap 240 are then written to full bitmap 250. The change bitmap 240 is used to temporarily store the rasterized regions of the print output for the document. The resolution of the change bitmap may be set at many different resolutions. For example, the resolution may be at half printer resolution, full printer resolution, or some other determined resolution. For example, the resolution may be a configurable parameter and may be set on the capabilities of the output device. Storing the full bitmap 250 in memory can place significant demands on the system, especially for large paper sizes. For example, an 11″×17″ paper size uses 11×17×300×300×4 bytes/pixel=approx. 64 mb). This memory requirement can be reduced by breaking the full bitmap into tiles or bands so that only part of the bitmap is stored in memory at any given time. For example, if four bands are used, the memory requirement at a given time would be 16 mb at a time instead of 64 mb.

According to one embodiment, when the change bitmap 240 is being written to the full bitmap 250, the metafile 230 is replayed to the full bitmap and then destroyed. The resolution of the metafile is also generally dependent on the capabilities of the output device (printer).

The full bitmap 250 is the cumulative record of what is to be printed to printer 260. Following the final iteration of writing to the full bitmap, the full bitmap is sent to printer 260 for printing. ‘Dirty’ regions (containing transparent pixels) of the bitmap are blitted to the printer, and the metafile is replayed the bitmap and the printer. The full bitmap may also be compressed to speed up the printing process. According to one embodiment, the full bitmap is compressed using JPEG compression. Other compression methods may also be used.

As printing devices have different capabilities, their capabilities may be exploited to produce better looking output. For example, if alpha blending is supported, then the printer can blend transparent content with high fidelity content, while preserving content in its native format. Any other capabilities of the output device may also be considered when determining what objects to rasterize and what objects to write to the metafile.

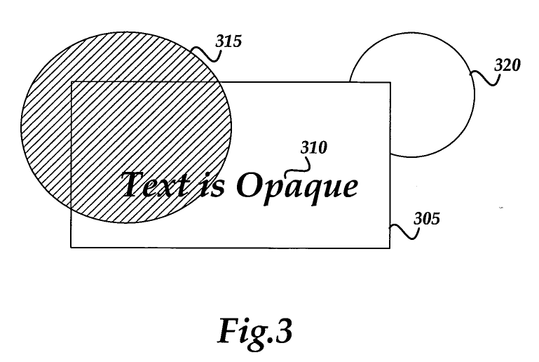

FIG. 3 illustrates an exemplary document that contains transparent and opaque objects. As illustrated, document 300 includes opaque objects 305, 310 and 320 and transparent object 315. Transparent object 315 is located over opaque object 305 and text 310. When document 300 is printed, object 320 and the portion of objects 305, 310 and 315 that are not overlapped by transparent object 315 is written to the metafile. Transparent object 315 and the portion of the objects that it overlaps are rasterized and stored in the bitmap. FIG. 3 will be referenced as an example by the process described below.

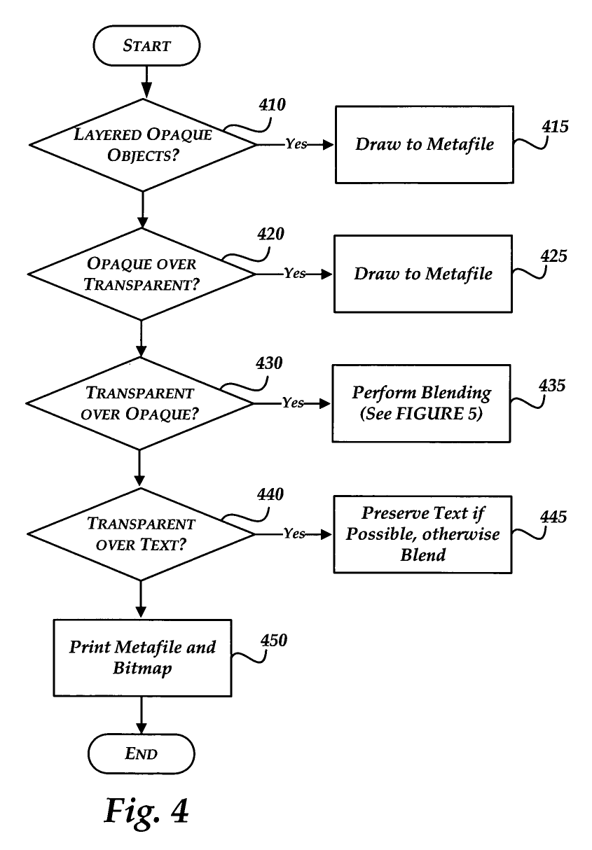

Referring now to FIGS. 4-6, an illustrative process for printing a document containing transparent and opaque objects will be described. Although the embodiments described herein are presented in the context of a print manager 26 and a word processing application program 10, other types of application programs that print transparent objects may be utilized. For instance, the embodiments described herein may be utilized within a presentation application program, a spreadsheet application program, or a drawing or computer-aided design application program, and the like.

When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments of the described herein are referred to variously as operations, structural devices, acts or modules. These operations, structural devices, acts and modules may be implemented in software, in firmware, in special purpose digital logic, and any combination thereof.

FIG. 4 illustrates a process for printing layered opaque and transparent objects. There are many different ways that objects that are within a document can be layered. For example, opaque objects may be placed over opaque objects; transparent objects may be placed over an opaque object; transparent objects may be placed over text; text may be placed over transparent objects and the like. Other layering combinations may also be included within a document.

After a start operation, the process flows to decision block 410, where a determination is made as to whether there are layered opaque objects. Examples of layered opaque objects may be seen in FIG. 3. One example in FIG. 3 is where object 305 is layered over object 320. As can be seen, a region of circle 320 is beneath object 305 and may not be seen. In this case, the opaque objects are drawn to the metafile (415).

Moving to decision operation 420, a determination is made as to whether an opaque object is placed over a transparent object. When an opaque object is placed over a transparent object the opaque object is drawn on top of the transparent one and placed in the metafile (425).

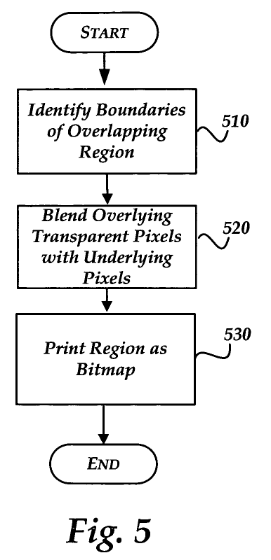

Moving to decision operation 430, a determination is made as to whether a transparent object is placed over an opaque object. When a transparent object is placed over an opaque object, blending is performed (435) (See FIG. 5 and related discussion). An example of a transparent object that is placed over an opaque object may be seen in FIG. 3. Referring to FIG. 3, the semi-transparent circle 315 is placed over a portion of both opaque object 305 and text 310. The portion of object 305 and the portion of text 310 that is beneath the circle 315 are still visible since object 315 is semi-transparent. According to one embodiment, the overlapping region is blended and printed to the bitmap.

Moving to decision operation 440, a determination is made as to whether a transparent object is placed over text. When a transparent object is placed over text, the process moves to operation 445 where the text is preserved if possible. The example in FIG. 3 shows text 310 that is located beneath a semi-transparent circle 315. In this case, the transparent shape 315 and everything below it is blended and printed through the bitmap. The text outside of shape 315 is not obstructed and is printed to the metafile. When there are multiple transparent layers over text, the colors of all of the layers are blended for each pixel in the region of overlap.

Moving to operation 450, the metafile and bitmap are played to the printer. The metafile is replayed onto the printer and into the bitmap such that the opaque content can be blended with the rasterized transparent layers that are contained within the bitmap. The bitmap is then drawn on the printer.

The process then moves to an end operation and returns to processing other actions.

FIG. 5 shows blending overlapping transparent and opaque regions. After a start operation, the process flows to operation 510 where the boundaries of the overlapping region(s) are identified. The overlapping region contains transparent content and opaque content. For example, referring to FIG. 3 semi-transparent circle 315 overlaps a portion of opaque rectangle 305 as well as a portion of opaque text 310. In this case, the overlapping region includes the opaque content that is located beneath circle 315. According to one embodiment, the boundaries of the overlapping region may be identified using alpha information. Moving to operation 520, the overlying transparent pixels are blended with the underlying pixels. Flowing to operation 530 the overlapping region is printed to the bitmap. The process then moves to an end operation and returns to processing other actions.

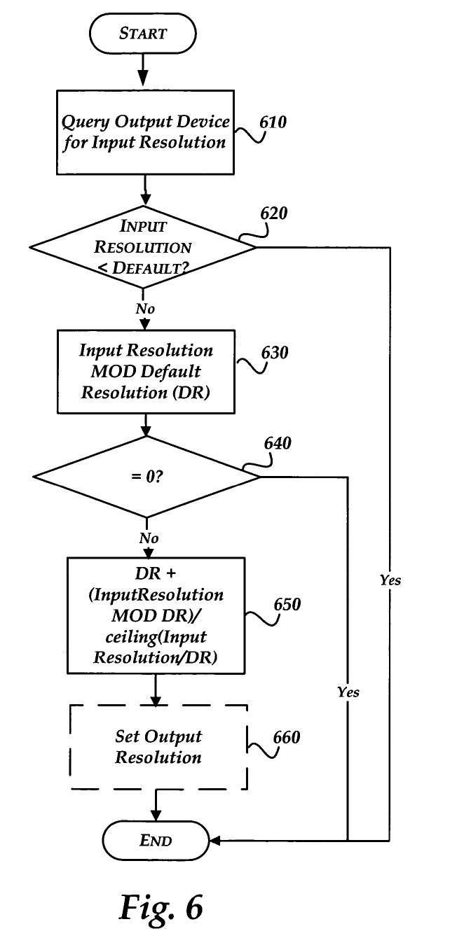

FIG. 6 illustrates selecting a resolution for the output of the document. After a start operation, the process flows to operation 610 where the output device is queried for its input resolution.

Flowing to decision operation 620, a determination is made as to whether the input resolution is less than the default resolution. The default resolution may be set at different resolutions, including: half printer resolution; full printer resolution, or some other determined resolution. For example, if the default resolution is 600 ppi, then the determination would be whether the input resolution is less than 600 ppi. According to one embodiment, when the resolution is less than the default resolution, the selected resolution maintains the default resolution. When the input resolution is not less than the default resolution, the process flows to operation 630.

At operation 630, the modulus operator divides the input resolution by the default resolution. Moving to decision operation 640, a determination is made as to whether the result is 0. When the result is 0, the default resolution is maintained and the process flows to an end block and returns to processing other actions. When the result is not zero, the process flows to operation 650 where the resolution is set using the following formula: Default Resolution+(InputResolution MOD Default Resolution (300)/ceiling(InputResolution/(Default Resolution). This formula yields the smallest factor of the device input resolution that is greater than the default resolution.

Moving to operation 660, the output resolution may be set. If the user does not specify the output resolution, an appropriate default is determined. As a general rule, most printers have an input resolution that is a multiple of 300 ppi (i.e. 300, 600, 1200, 2400, and the like). Generally, the best quality for the device is usually obtained at resolutions that are a factor or multiple of the printer's input resolution. Therefore, the output resolution is set at a factor of the input resolution.

The process then moves to an end block and returns to processing other actions.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A computer-implemented method for transparency printing, comprising:
accessing a document that comprises transparent content and opaque content;
determining raster content to rasterize to a bitmap; wherein the raster content includes at least a portion of the transparent content and a portion of the opaque content;
rasterizing the raster content to the bitmap;
printing remaining content to a metafile; and
playing the metafile onto an output device and to the bitmap such that the remaining content that is contained within the metafile can be blended with the raster content that is contained within the bitmap.

2. The computer-implemented method of claim 1, wherein determining the raster content to rasterize comprises determining a layering of the transparent content and the opaque content within the document.

3. The computer-implemented method of claim 2, wherein determining the layering of the transparent content and the opaque content within the document comprises determining when transparent content is over opaque content and when transparent content is over the opaque content determining at least some of the content to be raster content.

4. The computer-implemented method of claim 3, wherein determining when the transparent content is over the opaque content comprises determining an overlapping region that includes an area where the transparent content overlaps the opaque content.

5. The computer-implemented method of claim 4, wherein rasterizing the raster content to the bitmap comprises blending overlying transparent pixels with underlying pixels and printing the overlapping region to the bitmap.

6. The computer-implemented method of claim 1, further comprising accessing the document in layers.

7. The computer-implemented method of claim 3, wherein determining the layering of the transparent content and the opaque content within the document comprises determining when transparent content is over text; and preserving the text when possible.

8. The computer-implemented method of claim 1, further comprising determining an input resolution of the output device and adjusting a resolution that relates to the metafile and the bitmap in response.

9. A computer-readable medium having computer-executable instructions for printing a document containing transparent content and opaque content, comprising:
determining content to rasterize to a bitmap; wherein the content includes a majority of the transparent content and the opaque content that is covered by the transparent content;
rasterizing the content to the bitmap;
printing remaining content to a metafile; and
playing the metafile onto an output device and to the bitmap such that the remaining content that is contained within the metafile is blended with the content that has been rasterized to the bitmap.

10. The computer-readable medium of claim 9, wherein determining the content to rasterize to the bitmap comprises determining a layering of the transparent content and the opaque content within the document.

11. The computer-readable medium of claim 10, wherein determining the layering of the transparent content and the opaque content within the document comprises determining an overlapping region of an area where the transparent content overlaps the opaque content.

12. The computer-readable medium of claim 11, wherein rasterizing the content to the bitmap comprises blending overlying transparent pixels with underlying pixels and printing the overlapping region to the bitmap.

13. The computer-readable medium of claim 11, wherein determining the layering of the transparent content and the opaque content within the document comprises determining when transparent content is over text; and writing the text to the metafile when possible.

14. The computer-readable medium of claim 9, further comprising querying an output device for an input resolution; comparing the input resolution to a default resolution; and setting a resolution in response to the comparison.

15. A system for printing, comprising:
an application configured to output a document that includes transparent objects and opaque objects; and
a print manager coupled to the application and that is configured to perform actions; comprising:
determining a portion of opaque content to rasterize to a bitmap;
rasterizing the opaque content and transparent content to the bitmap;
printing remaining portion of the opaque content to a metafile; and
playing the metafile onto an output device and to the bitmap such that the remaining content that is contained within the metafile is blended with the content that has been rasterized to the bitmap.

16. The system of claim 15, wherein determining the portion of the opaque content to rasterize to the bitmap comprises determining a layering of the transparent content and the opaque content within the document.

17. The system of claim 16, wherein determining the layering of the transparent content and the opaque content within the document comprises determining an overlapping region of an area where the transparent content overlaps the opaque content.

18. The system of claim 17, wherein rasterizing the content to the bitmap comprises blending overlying transparent pixels with underlying pixels and printing the overlapping region to the bitmap.

19. The system of claim 17, wherein determining the layering of the transparent content and the opaque content within the document comprises determining when transparent content is over text; and writing the text to the metafile when possible.

20. The system of claim 15, further comprising querying an output device for an input resolution; comparing the input resolution to a default resolution; and setting a resolution in response to the comparison.
